(19) United States
(12) Patent Application Publication
(10) Pub. No.: US 2017/0060905 A1
(43) Pub. Date: Mar. 2, 2017

(54) ELECTRONIC APPARATUS AND METHOD

(71) Applicant: Kabushiki Kaisha Toshiba, Tokyo (JP)

(72) Inventor: Daisuke Hirakawa, Saitama Saitama (JP)

(21) Appl. No.: 15/248,409

(22) Filed: Aug. 26, 2016

Related U.S. Application Data
(60) Provisional application No. 62/210,933, filed on Aug. 27, 2015.

(51) Int. Cl. G06F 17/30; G06K 9/00; G06K 9/62

(52) U.S. Cl. CPC G06F 17/30268; G06K 9/628; G06K 9/00281; G06K 9/00248; G06F 17/30528; G06F 17/30554

(57) ABSTRACT

According to one embodiment, an electronic apparatus includes a hardware processor configured to obtain a plurality of first images to which a capture date is added, select a second image from the first images based on a result of analysis of each of the obtained first images, obtain past data related to a period in which the second image is captured, based on a date added to the selected second image, and present the selected second image and the obtained past data in association with each other.

### CROSS-REFERENCE TO RELATED APPLICATIONS

This application claims the benefit of U.S. Provisional Application No. 62/210,933, filed Aug. 27, 2015, the entire contents of which are incorporated herein by reference.

### FIELD

Embodiments described herein relate generally to an electronic apparatus and a method.

### BACKGROUND

Recently, various types of electronic devices, such as a notebook or desktop personal computer (PC), a tablet computer and a smartphone, have become widespread.

In these types of electronic devices, an image (photograph) captured by using, for example, a digital camera can be accumulated in the electronic device and can be displayed on the screen of the electronic device.

A large number of images may be accumulated in the electronic device. In this case, even if an image is displayed on the screen of the electronic device, for example, the situation in which the image was captured may not be immediately recognized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of the external appearance of an electronic apparatus according to an embodiment.

FIG. 2 is a diagram showing an example of the system configuration of the electronic apparatus.

FIG. 3 is a block diagram showing an example of the function configuration of the electronic apparatus.

FIG. 4 is a flowchart showing an example of the processing procedure of the electronic apparatus.

FIG. 5 is a flowchart showing an example of the procedure of a process for obtaining past data.

FIG. 6 is an illustration of an example of an image presentation screen.

FIG. 7 is an illustration of an example of the image presentation screen if the number of presentation images is greater than a predetermined number.

### DETAILED DESCRIPTION

Various embodiments will be described hereinafter with reference to the accompanying drawings.

In general, according to one embodiment, an electronic apparatus includes a hardware processor configured to: obtain a plurality of first images to which a capture date is added; select a second image from the first images based on a result of analysis of each of the obtained first images; obtain past data related to a period in which the second image is captured, based on a date added to the selected second image; and present the selected second image and the obtained past data in association with each other.

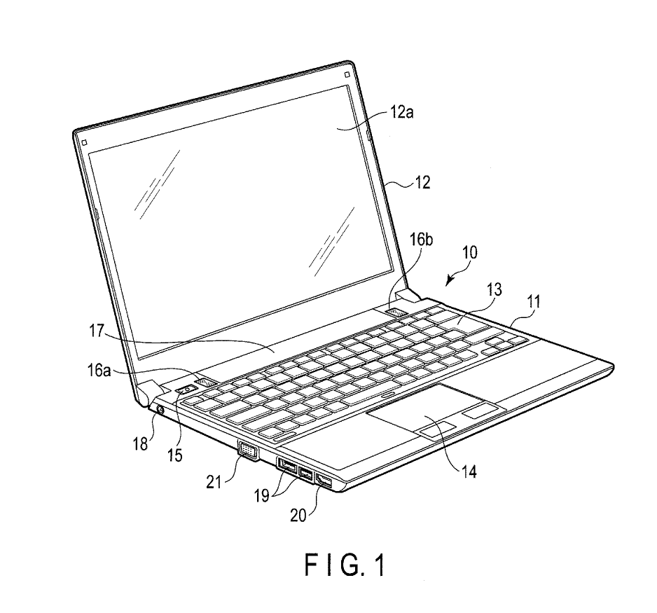

FIG. 1 is a perspective view showing the external appearance of an electronic apparatus according to an embodiment. The electronic apparatus of the present embodiment may be realized as a notebook or desktop personal computer, a tablet computer, a smartphone or various other types of information apparatuses. In the example shown in FIG. 1, the electronic apparatus is realized as a notebook personal computer. In the explanation below, the electronic apparatus is assumed to be realized as a notebook personal computer.

As shown in FIG. 1, the electronic apparatus 10 includes a main body (computer main body) 11 and a display unit 12. A display such as a liquid crystal display (LCD) 12a is incorporated into the display unit 12.

The display unit 12 is attached to the main body 11 such that the display unit 12 is rotatable between an open position where the upper surface of the main body 11 is exposed and a closed position where the upper surface of the main body 11 is covered by the display unit 12. The main body 11 includes a housing having a thin box-like shape. For example, a keyboard 13, a touchpad 14, a power source switch 15 and speakers 16a and 16b are provided on the upper surface of the main body 11.

The electronic apparatus 10 is configured to receive power from a battery 17. In the present embodiment, the battery 17 is, for example, accommodated in the electronic apparatus 10.

A power source connector (DC power source input terminal) 18 is provided in the main body 11. The power source connector 18 is provided in a side surface of the main body 11, for example, in the left side surface. An external power source device is detachably connected to the power source connector 18. As the external power source device, an AC adapter can be used. The AC adapter is a power source device for converting commercial power (AC power) into DC power.

The electronic apparatus 10 is driven by power supplied from the battery 17 or power supplied from the external power source device. If no external power source device is connected to the power source connector 18 of the electronic apparatus 10, the electronic apparatus 10 is driven by power supplied from the battery 17. If the external power source device is connected to the power source connector 18 of the electronic apparatus 10, the electronic apparatus 10 is driven by power supplied from the external power source device. The power supplied from the external power source device is also used to charge the battery 17.

Some USB ports 19, a High-definition Multimedia Interface (HDMI [registered trademark]) output terminal 20 and an RGB port 21 are provided in the main body 11.

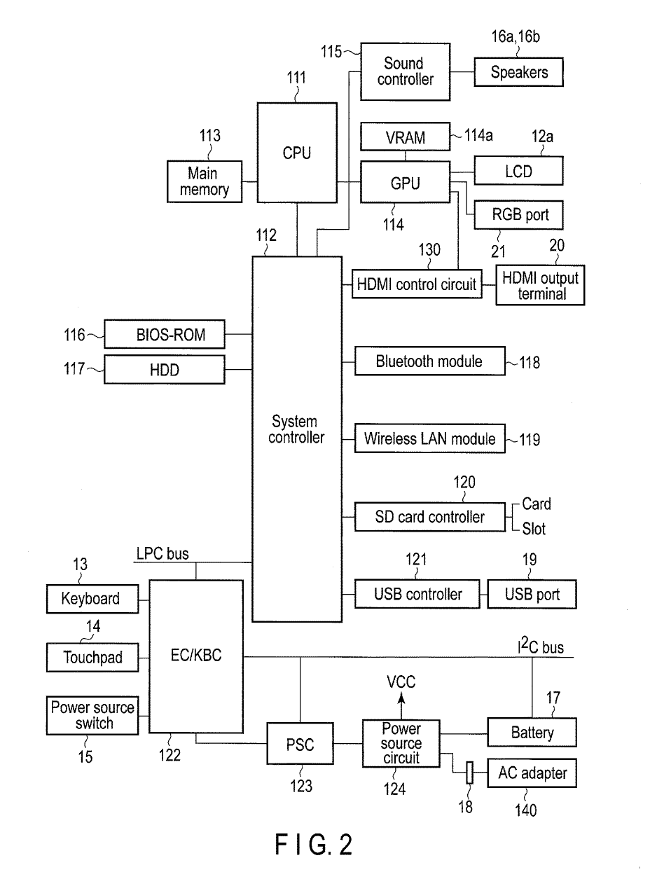

FIG. 2 shows the system configuration of the electronic apparatus 10 shown in FIG. 1. The electronic apparatus 10 includes, for example, a CPU 111, a system controller 112, a main memory 113, a graphics processing unit (GPU) 114, a sound controller 115, a BIOS-ROM 116, a hard disk drive (HDD) 117, a Bluetooth (registered trademark) module 118, a wireless LAN module 119, an SD card controller 120, a USB controller 121, an embedded controller/a keyboard controller IC (EC/KBC) 122, a power source controller (PSC) 123 and a power source circuit 124.

The CPU 111 is a hardware processor configured to control the operations of the components of the electronic apparatus 10. The CPU 111 executes various programs loaded from the HDD 117 which is a storage device into the main memory 113. These programs include an operating system (OS) and application programs. The application programs include an application program (photo-viewer application) which allows the user to view various types of images.

The photo-viewer application is capable of receiving an image (photograph) from a digital camera, external storage (a USB memory or an SD card), a mobile device (smartphone), etc., and storing (accumulating) the image in an image folder of the HDD 117. The photo-viewer application is capable of presenting the accumulated images to the user to allow the user to view an image. Each image presented by the photo-viewer application is an image file (data) having the JPEG or another file format. To each image (data), for example, date data indicating the date (and time) at which the image was captured is added as metadata.

The application program includes, for example, an application program (calendar application) for managing the schedule of the user of the electronic apparatus 10, and an application program (social networking service [SNS] application) for using an SNS in addition to the photo-viewer application.

The CPU 111 executes a basic input/output system (BIOS) stored in the BIOS-ROM 116 which is a nonvolatile memory. The BIOS is a system program for hardware control.

The system controller 112 is a bridge device configured to connect the CPU 111 and each component. The system controller 112 includes a built-in Serial ATA controller for controlling the HDD 117. The system controller 112 communicates with each device on a Low Pin Count (LPC) bus.

The GPU 114 is a display controller configured to control the LCD 12a used as a display (monitor) of the electronic apparatus 10. The GPU 114 generates a display signal (LVDS signal) to be supplied the LCD 12a from the display data stored in a video memory (VRAM) 114a.

Further, the GPU 114 is capable of generating an HDMI video signal and an analog RGB signal from display data. The HDMI output terminal 20 is capable of transmitting an HDMI video signal (uncompressed digital video signal) and a digital audio signal to an external display connected by a cable. The analog RGB signal is supplied to an external display via the RGB port 21.

FIG. 2 shows an HDMI control circuit 130 which is an interface configured to transmit an HDMI video signal and a digital audio signal to an external display via the HDMI output terminal 20.

The sound controller 115 is a sound source device and outputs the audio data to be reproduced to, for example, speakers 16a and 16h.

The Bluetooth module 118 is a module configured to wirelessly communicate with devices compatible with Bluetooth, using Bluetooth.

The wireless LAN module 119 is a module configured to perform wireless communication conforming to, for example, the IEEE 802.11 standard.

The SD card controller 120 writes and reads data relative to a memory card inserted into a card slot provided in the main body 11.

The USB controller 121 communicates with an external device connected via each USB port 19.

The EC/KBC 122 is connected to the LPC bus. The EC/KBC 122 is mutually connected to the PSC 123 and the battery 17 via a serial bus such as an I²C bus.

The EC/KBC 122 is a power management controller configured to manage power of the electronic apparatus 10. For example, the EC/KBC 122 is realized as a single-chip microcomputer including a built-in keyboard controller controlling the keyboard (KB) 13, the touchpad 14, etc. The EC/KBC 122 has a function for turning on and off the electronic apparatus 10 in accordance with the operation of the power source switch 15 by the user. The control of power-on and power-off of the electronic apparatus 10 is performed in cooperation with the EC/KBC 122 and the PSC 123. If the PSC 123 receives an on-signal transmitted from the EC/KBC 122, the PSC 123 controls the power source circuit 124 and turns on the electronic apparatus 10. If the PSC 123 receives an off-signal transmitted from the EC/KBC 122, the PSC 123 controls the power source circuit 124 and turns off the electronic apparatus 10.

The power source circuit 124 provides power (operating power Vcc) to be supplied to each component, using power supplied from the battery 17 or power supplied from an AC adapter 140 connected to the main body 11 as an external power source device.

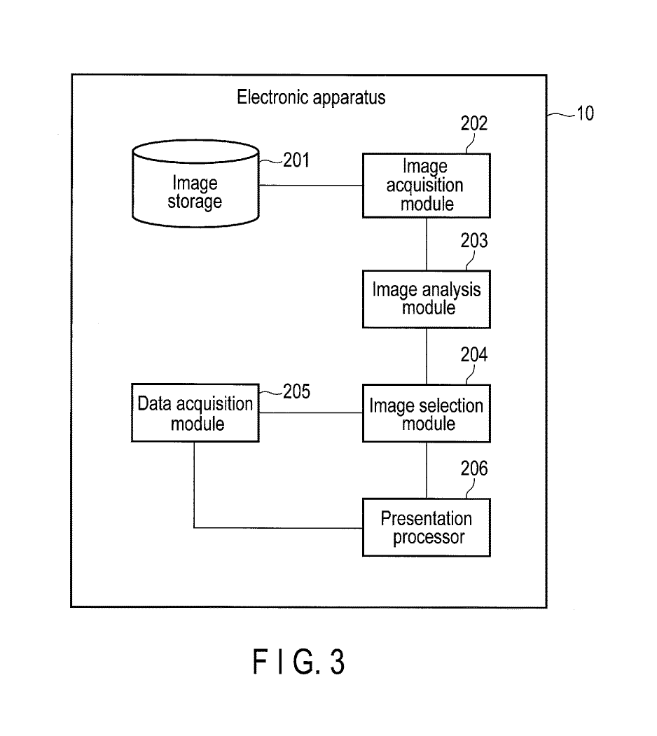

FIG. 3 is a block diagram showing the function configuration of the electronic apparatus 10 according to the present embodiment. As shown in FIG. 3, the electronic apparatus 10 includes an image storage 201, an image acquisition module 202, an image analysis module 203, an image selection module 204, a data acquisition module 205 and a presentation processor 206.

In the present embodiment, the image storage 201 is assumed to be stored in the HDD 117, etc.

In the present embodiment, a part of or all of the modules 202 to 206 is/are realized if the CPU 111 executes the above photo-viewer application (software). A part of or all of the modules 202 to 206 may be realized by hardware such as an integrated circuit (IC) or may be realized as a structure of combination between software and hardware.

A plurality of images captured by using, for example, a digital camera or a camera mounted on a smartphone (hereinafter, simply referred to as a camera) are stored (accumulated) in the image storage 201. Each image stored in the image storage 201 includes a large number of pixels having values (pixel values) indicating the strength of light (brightness) and the color, etc. At least date data indicating the date (and time) at which the image was captured is added to each image stored in the image storage 201. In addition, location data indicating the location in which the image was captured may be added to each image stored in the image storage 201. Apart from an image captured by a camera, for example, an image obtained through an external network such as the Web may be accumulated in the image storage 201.

The image acquisition module 202 obtains a plurality of images (first images) stored in the image storage 201.

The image analysis module 203 analyzes each of the images obtained by the image acquisition module 202. If a person is included in an image obtained by the image acquisition module 202, the image analysis module 203 detects the face area of the person from the image and calculates the feature amount of the face area using the pixel values of the pixels included in the face area. The feature amount includes a feature amount indicating the positional relationship between parts in the face area such as the eyes, nose and mouth, and a feature amount indicating the color or shape of these parts.

Based on the result of analysis of each of the images by the image analysis module 203, the image selection module 204 selects at least one image (second image) to be presented to the user from the images. Specifically, the image selection module 204 selects a plurality of images each including the face area in which the feature amount calculated by the image analysis module 203 is similar.

Based on the date data added to each of the images selected by the image selection module 204, the data acquisition module 205 obtains data (past data) related to the period in which the image was captured. Past data may be obtained from the inside of the electronic apparatus 10 or may be obtained through an external network (external server device) such as the Web.

The presentation processor 206 presents (displays) each image selected by the image selection module 204 and the past data obtained by the data acquisition module 205 in association with each other.

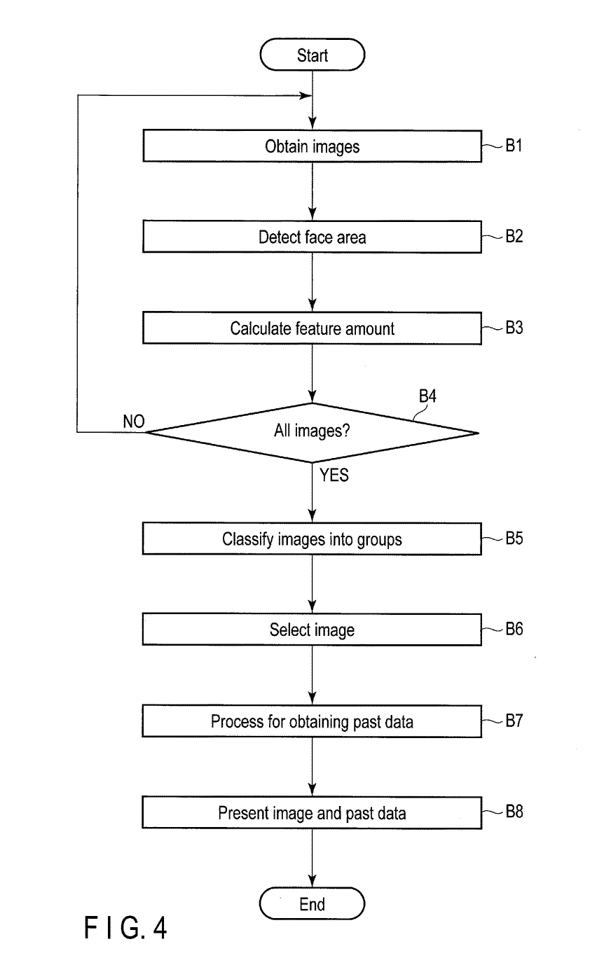

Now, this specification explains the processing procedure of the electronic apparatus 10 of the present embodiment with reference to the flowchart shown in FIG. 4.

The user is able to activate (execute) the photo-viewer application in the electronic device 10 by operating the electronic apparatus 10.

If the photo-viewer application is activated in this manner, the image acquisition module 202 obtains a plurality of images stored in the image storage 201 (block B1).

As explained above, date data and location data are added to an image captured by a camera out of the images stored in the image storage 201. In many cases, date data or positional data is not added to, for example, an image obtained through an external network out of the images stored in the image storage 201. Therefore, in the present embodiment, if only an image captured by a camera is presented to the user, only an image to which date data and location data are added may be obtained out of the images stored in the image storage 201.

The image acquisition module 202 may directly obtain an image from, for example, a digital camera, external storage and a mobile device.

Subsequently, the image analysis module 203 performs a process for analyzing each of the images obtained in block B1. The image analysis module 203 performs a process for analyzing a person (in other words, the area of a person) included in each image. In this case, the processes of blocks B2 and B3 are applied to each of the images obtained in block B1. In the explanation below, an image to be processed in blocks B2 and B3 is referred to as the target image.

The image analysis module 203 detects the face area of a person included in the target image from the target image (block B2). The image analysis module 203 detects an area presumed as the face area, using the pixel values of pixels of the image.

The target image may include more than one person or may not include a person. If the target image includes more than one person, the face area of each person is detected. If no person is included in the target image, no face area is detected.

Based on the pixel values of pixels included in each face area detected in block B3, the image analysis module 203 calculates the feature amount of the face area (block B3). The image analysis module 203 calculates the feature amount indicating the positional relationship between parts in the face area such as the eyes, nose and mouth, and the feature amount indicating the color or shape of these parts.

The feature amount calculated by the image analysis module 203 may include the degree of smile, the degree of frontality (orientation) and the definition of the face in each face area obtained by applying an image process to the face area. Further, the feature amount calculated by the image analysis module 203 may include the position and size of each face area. The degree of smile, the degree of frontality, the definition, the position, the size, etc., are used as a supplementary feature amount.

If a plurality of face areas are detected from the target image in block B2, the feature amount of each of the face areas is calculated. If no face area is detected from the target image in block B2, the process of block B3 may be omitted.

After the process of block B3 is performed, whether or not the processes of blocks B2 and B3 are performed for all of the images obtained in block B1 is determined (block B4).

If it is determined that the processes are not performed for all of the images (NO in block B4), the procedure is repeated from block B1. In this case, the processes of blocks B2 and B3 are performed for images to which the processes have not been applied.

If it is determined that the processes are performed for all of the images (YES in block B4), the image selection module 204 classifies the images into a plurality of groups (clusters) based on the feature amount calculated for each of the images (specifically, for each of the face areas detected from the images). In this case, a plurality of images from which face areas having similar feature amounts have been detected (in other words, a plurality of images including the same person) are classified into the same group.

If a plurality of face areas are detected from an image (in other words, if the feature amount of a plurality of face areas is calculated), the feature amount of the face area having the highest degree of smile, frontality and definition is used out of the face areas. Out of the face areas, the feature amount of the face area located near the central portion of the image may be used, or the feature amount of the largest face area may be used.

The image selection module 204 selects, as an image to be presented to the user (presentation image), an image classified into at least one of the groups into which the images obtained in block B1 are classified (block B6). Specifically, the image selection module 204 specifies the group having the largest number of classified images out of the groups, and selects the images classified into the specified group as presentation images.

The image selection module 204 may select, for example, the images classified into the group specified by the user out of the groups as presentation images.

Subsequently, the data acquisition module 205 performs a process for obtaining past data based on the date data added to the images (presentation images) selected in block B6 (block B7). Through the process for obtaining past data, past data related to the period in which each presentation image was captured (in other words, past data indicating the situation in which each presentation image was captured) is obtained. The details of the process for obtaining past data are explained later.

After the process of block B7 is performed, the presentation processor 206 presents a presentation image and past data (block B8). In this case, for example, a screen including a presentation image and past data (in other words, an image presentation screen) is displayed on the display (LCD 12a) of the electronic apparatus 10. The details of the image presentation screen displayed on the display of the electronic apparatus 10 are explained later.

In the procedure shown in FIG. 4, an analysis process is performed for a person included in an image. In this case, only an image including a person may be obtained in block B1.

In the procedure shown in FIG. 4, a presentation image is selected based on the feature amount of the face area. However, for example, a presentation image may be selected based on location data (specifically, the location in which each image was captured indicated by location data) added to each of the images obtained in block B1. In this case, for example, images to which location data indicating a location included in a predetermined range is added may be classified into the same group. The images classified into the group may be selected as presentation images. Further, a presentation image may be selected by applying an analysis process (a process for recognizing an object) to an object included in each of the images obtained in block B1. In this case, for example, images including the same (or the same type of) object may be classified into the same group. The images classified into the group may be selected as presentation images.

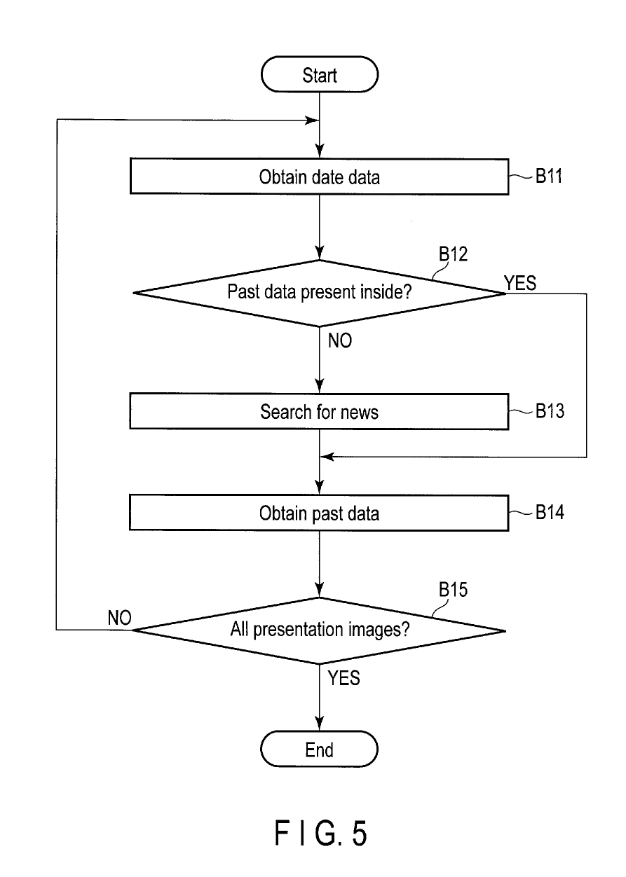

Now, this specification explains the procedure of a process for obtaining past data (the process of block B7 shown in FIG. 4) performed by the data acquisition module 205 with reference to the flowchart shown in FIG. 5.

In the process for obtaining past data, the processes of blocks B11 to B14 are performed for each presentation image. Each presentation image to be processed in blocks B11 and B14 is referred to as the target presentation image.

In this case, the data acquisition module 205 obtains date data added to the target presentation image (block B11). The date data obtained by the data acquisition module 205 is data indicating the date at which the target presentation image was captured.

Subsequently, the data acquisition module 205 determines whether or not past data is present inside the electronic apparatus 10 based on the obtained date data (block B12). The process of block B12 is performed based on whether or not an event (for example, the birthday or another plan) is registered inside the electronic apparatus 10 (for example, the calendar application) in association with the date (specifically, a predetermined period including the date) indicated by date data obtained by the data acquisition module 205. If an event is registered inside the electronic apparatus 10, it is determined that past data is present inside the electronic apparatus 10. If no event is registered in the electronic apparatus 10, it is determined that past data is not present inside the electronic apparatus 10.

Here, the calendar application is explained as an example. However, if comments are posted on the social network used in the SNS application, past data may be determined to be present inside the electronic apparatus 10.

If it is determined that past data is not present inside the electronic apparatus 10 (NO in block B12), the data acquisition module 205 searches an external network (database) such as the Web for news distributed in a predetermined period including the date indicated by the obtained date data (in other words, within approximately one month before and after the date) (block B13).

After the process of block B13 is performed, the data acquisition module 205 obtains past data based on the result of search (block B14).

In many cases, a plurality of news items (articles) are included in the above result of search. In this case, the data acquisition module 205 is capable of analyzing each of news items (for example, the tile of each news item) included in the result of search and obtaining a word (or a character string) having a high frequency of appearance as past data. Past data may be obtained from the result of search, using a dictionary in which a word obtainable as past data is registered in advance.

To obtain past data which is more related to the user, the location data added to the target presentation image may be used. Specifically, news related to the location (region) indicated by the location data added to the target presentation image may be searched for.

If an object is included in the target presentation image, a word related to the object which is included in the target presentation image and is recognized by a process for recognizing an object may be obtained as past data.

If a character string described in a notice, etc., is included in the target presentation image, the character string (word) which is included in the target presentation image and is recognized by a process for recognizing a character may be obtained as past data.

Further, past data may be obtained, using user data registered on the social networking service used in the SNS application. Specifically, past data may be obtained from news of interest to the user specified on the social networking service.

If past data cannot be obtained from the result of search, past data may not be obtained.

If it is determined that past data is present inside the electronic apparatus 10 (YES in block B12), the data acquisition module 205 obtains the past data (block B14). Specifically, if an event is registered at the date indicated by the date data obtained by the data acquisition module 205 in the calendar application, etc., the title of the event and the like may be obtained as past data.

As described above, if comments are posted on the social networking service used in the SNS application, the comments (or a word or character string included in the comments) may be obtained as past data.

After the process of block B14 is performed, whether or not the processes of blocks B11 to B14 are performed for all of the presentation images is determined (block B15).

If it is determined that the processes are not performed for all of the presentation images (NO in block B15), the procedure is repeated from block B11. In this case, the processes of blocks B11 to B14 are performed for, as the target presentation image, a presentation image to which the processes have not been applied.

If it is determined that the processes are performed for all of the presentation images (YES in block B15), the process for obtaining past data is terminated.

Through the process for obtaining past data, past data is obtained for each presentation image. In this manner, it is possible to present each presentation image to the user with past data obtained for the presentation image on the image presentation screen.

In general, an event (or the title of an event) registered in the calendar application, etc., is considered to show the situation in which the presentation image was captured by the user more accurately than news. Therefore, in the present embodiment, as shown in FIG. 5, the tile of event registered in the calendar application, etc., is preferentially obtained as past data.

In the above explanation of FIG. 5, a past data item is obtained for each presentation image. However, if the number of presentation images is less than a predetermined number, a plurality of past data items may be obtained for each of the presentation images.

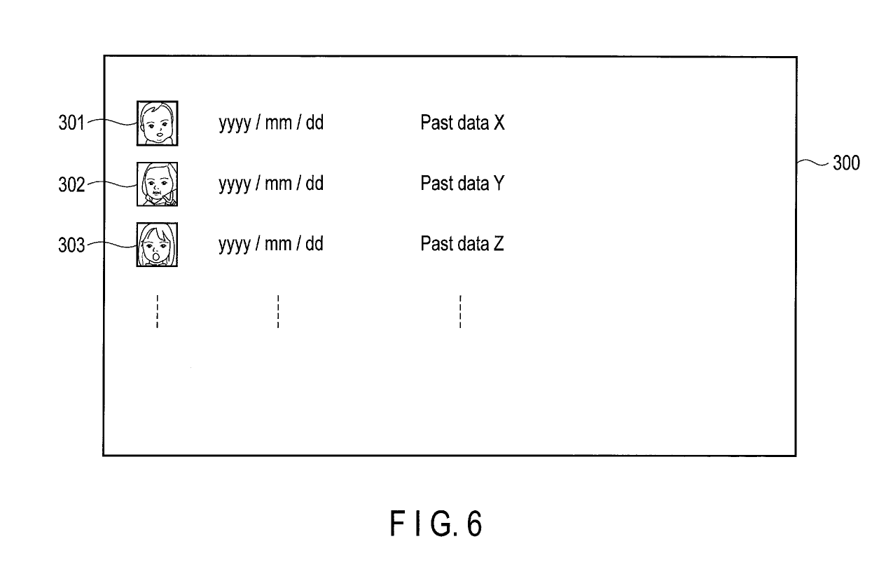

Now, this specification explains the image presentation screen. FIG. 6 shows an example of the image presentation screen. For example, in association with thumbnails respectively corresponding to a plurality of presentation images, the date data (specifically, the date indicated by the date data) added to the presentation images and past data are displayed on the image presentation screen 300 shown in FIG. 6.

In the example shown in FIG. 6, the date “yyyy/mm/dd” and past data X are displayed on the image presentation screen 300 in association with thumbnail 301 (including the face area) corresponding to a presentation image. Past data X is past data (a word or a character string) obtained by performing the processes of blocks B11 to B14 shown in FIG. 5 for the presentation image corresponding to thumbnail 301.

In a similar way, the date “yyyy/mm/dd” and past data Y are displayed on the image presentation screen 300 in association with thumbnail 302 corresponding to a presentation image. Past data Y is past data (a word or a character string) obtained by performing the processes of blocks B11 to B14 shown in FIG. 5 for the presentation image corresponding to thumbnail 302.

Furthermore, the date “yyyy/mm/dd” and past data Z are displayed on the image presentation screen 300 in association with thumbnail 303 corresponding to a presentation image. Past data Z is past data (a word or a character string) obtained by performing the processes of blocks B11 to B14 shown in FIG. 5 for the presentation image corresponding to thumbnail 303.

In the above manner, past data is displayed on the image presentation screen 300 in association with each of presentation images (specifically, in association with each of thumbnails 301 to 303 corresponding to presentation images).

In FIG. 6, the dates are shown as “yyyy/mm/dd” for the sake of convenience. However, on the image presentation screen 300, thumbnails 301 to 303 are displayed in the order of dates (in chronological order).

The image presentation screen 300 shown in FIG. 6 is merely an example. The image presentation screen may be displayed in another form as long as a presentation image is displayed with past data.

If a large number of images are accumulated in the image storage 201, many presentation images may be selected. In this case, if all of the presentation images (specifically, all of the thumbnails corresponding to the presentation images) are displayed on the image presentation screen 300, the visibility for the presentation images is reduced.

In the present embodiment, if the number of presentation images is greater than a predetermined number (in other words, if a large number of presentation images are selected), only a predetermined number of presentation images are displayed on the image presentation screen based on each predetermined period out of the presentation images to which the dates applicable to the predetermined period are added (in other words, out of the presentation images which were captured in the predetermined period).

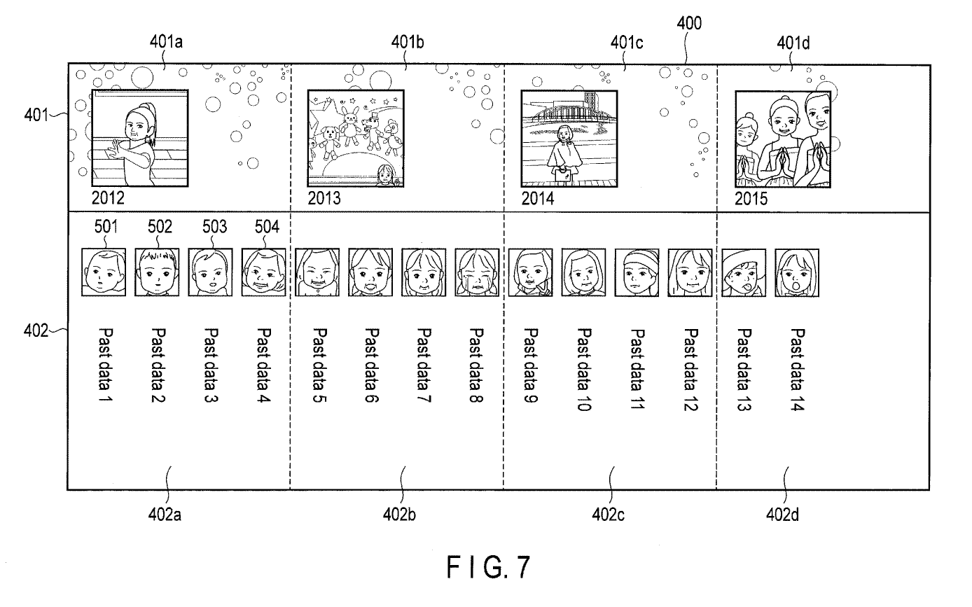

FIG. 7 shows an example of the image presentation screen which is displayed if the number of presentation images is greater than a predetermined number.

As shown in FIG. 7, a first area 401 and a second area 402 are provided on an image presentation screen 400.

The first area 401 includes sub-areas 401a to 401d each of which corresponds to the year in which each presentation image was captured. In each of sub-areas 401a to 401d, a plurality of presentation images which were captured in the year corresponding to the sub-area (in other words, presentation images to which the dates applicable to the year are added) are displayed as a slideshow.

In the example shown in FIG. 7, the presentation images which were captured in 2012 are displayed in sub-area 401a as a slideshow. The presentation images which were captured in 2013 are displayed in sub-area 401b as a slideshow. The presentation images which were captured in 2014 are displayed in sub-area 401c as a slideshow. The presentation images which were captured in 2015 are displayed in sub-area 401d as a slideshow.

In a manner similar to that of the first area explained above, the second area 402 includes sub-areas 402a to 402d each of which corresponds to the year in which each presentation image was captured. In each of sub-areas 402a to 402d, out of the presentation images which were captured in the year corresponding to the sub-area, a predetermined number of presentation images are displayed with past data corresponding to the presentation images. Past data corresponding to each presentation image is past data obtained by performing the processes of blocks B11 to B14 shown in FIG. 5 for the presentation image.

In a manner similar to that of sub-areas 401a to 401d explained above, sub-areas 402a to 402d correspond to 2012 to 2015, respectively.

In sub-area 402a, for example, presentation images (in other words, the thumbnails of presentation images) 501 to 504 respectively applicable to four periods in 2012 are displayed. Presentation image 501 is an image determined based on the feature amount (the degree of smile, the degree of frontality, the definition, the position or size of the face area, etc.) of the face area included in each of presentation images which were captured on, for example, January to March in 2012. Specifically, out of the presentation images which were captured on January to March in 2012, for example, the presentation image having the highest degree of smile, degree of frontality or definition, the presentation image in which the face area is located near the central portion, or the presentation image having the largest face area is used as presentation image 501. Out of the presentation images which were captured on January to March in 2012, for example, the presentation image to which the oldest date is added may be used as presentation image 501.

In a similar way, presentation image 502 is an image determined based on the feature amount of the face area included in each of presentation images which were captured on, for example, April to June in 2012.

Presentation image 503 is an image determined based on the feature amount of the face area included in each of presentation images which were captured on, for example, July to September in 2012.

Presentation image 504 is an image determined based on the feature amount of the face area included in each of presentation images which were captured on, for example, October to December in 2012.

As shown in FIG. 7, past data 1 to 4 are displayed in sub-area 402a in association with presentation images 501 to 504, respectively. Past data 1 to 4 include, for example, the title of the event registered in the calendar application, etc., and news retrieved through an external network such as the Web. Past data may be displayed in sub-area 402a in a different form (color, font, size, etc.,) depending on whether the past data is the title of the event registered in the calendar application, etc., or news retrieved through an external network such as the Web.

In the above explanation, presentation images 501 to 504 respectively applicable to the periods of January to March, April to June, July to September and October to December in 2012 are displayed in sub-area 402a. However, out of the presentation images which were captured in 2012, four images determined based on the feature amount of the face area included in each presentation image (for example, four presentation images having a high degree of smile) may be displayed in sub-area 402a. The number of presentation images displayed in sub-area 402a may be appropriately changed.

The above explanation regarding sub-area 402a is also applicable to the other sub-areas 402b to 402d. Thus, the detailed explanation of the other sub-areas is omitted.

If past data corresponding to presentation images to be displayed in sub-areas 402a to 402d is not obtained, only the presentation images may be displayed without displaying past data. Alternatively, the presentation images to be displayed in sub-areas 402a to 402d may be changed to other presentation images for which past data is obtained.

If there is no presentation image applicable to the period of July to September or October to December out of the periods of January to March, April to June, July to September and October to December, only the presentation images applicable to the periods of January to March and April to June may be displayed as shown by sub-area 402d corresponding to 2015 in FIG. 7.

If the user selects (specifies) a presentation image (in other words, the thumbnail of a presentation image) displayed in sub-areas 402a to 402d, the selected presentation image may be displayed in an enlarged view.

If the user selects past data displayed in sub-areas 402a to 402d, the detailed content related to the selected past data may be displayed. The detailed content related to past data may be obtained from the calendar application, etc., or may be obtained through an external network such as the Web, as described above.

As stated above, in the present embodiment, a plurality of images (the first images) to which the capture date (in other words, the date data indicating the capture date) is added are obtained. Based on the result of analysis of the obtained images, a presentation image (the second image) is selected from the obtained images. Based on the date added to the presentation image, past data indicating the situation in which the presentation image was captured is obtained. The presentation image and past data are presented in association with each other.

In the present embodiment, as past data, for example, an event (the title of an event) which is registered inside the electronic apparatus 10 (the calendar application) in association with the date added each presentation image is obtained. In the present embodiment, as past data, for example, news distributed in a period including the date added to each presentation image is obtained through an external network (an external server device).

In the present embodiment, this configuration enables the user to easily recognize, if a presentation image is presented, the situation in which the presentation image was captured. For example, the user can easily find out and view the desired image.

In the present embodiment, a plurality of images are analyzed to calculate the feature amount of the face area of a person included in each of the images. Based on the calculated feature amount, the images are classified into a plurality of groups. The images classified into at least one of the groups are selected as presentation images. Specifically, the group having the largest number of classified images is specified out of the groups. The images classified into the specified group are selected as presentation images.

In the present embodiment, presentation images are automatically selected based on the following point of view: there is a high possibility that a user who accumulates a large number of images classified into the same group (for example, a large number of images of a child) views the images of the child. Thus, the user can save the trouble of selecting a presentation image by hand.

In the present embodiment, if a plurality of presentation images are selected, the presentation images are presented in the order of dates added to the presentation images. In the present embodiment, if the number of presentation images is greater than a predetermined number (a first number), a predetermined number (a second number) of presentation images are presented for each predetermined period out of a plurality of presentation images to which the dates applicable to the predetermined period are added. In the present embodiment, by such a structure, even if the number of presentation images is large, the user can view the presentation images with improved visibility.

In the present embodiment, past data can be obtained based on the location (in other words, location data indicating the location) added to a presentation image, the result of a process for recognizing an object included in the presentation image, or the result of a process for recognizing a character included in the presentation image. Since the present embodiment has this configuration, it is possible to obtain past data which is more related to the user (or a presentation image). Thus, the user can more easily recognize the situation in which a presentation image was captured.

Each of various functions described in the present embodiment may be realized by a circuit (a processing circuit). For example, the processing circuit includes a programmed hardware processor such as a central processing unit (CPU). The processor performs each of the described functions by executing a computer program (a group of orders) stored in a memory. The processor may be a microprocessor including an electrical circuit. For example, the processing circuit includes a digital signal processor (DSP), an application-specific integrated circuit (ASIC), a microcontroller, a controller and other electrical circuit components. Each of the components described in the present embodiment other than the CPU may be also realized by a processing circuit.

Various types of processing of the present embodiment may be realized by a computer program. An effect similar to that of the present embodiment can be easily realized by merely installing a computer program into a computer through a computer-readable storage medium in which the computer program is stored and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus including a hardware processor configured to:
obtain a plurality of first images to which a capture date is added;
select a second image from the first images based on a result of analysis of each of the obtained first images;
obtain past data related to a period in which the second image is captured, based on a date added to the selected second image; and
present the selected second image and the obtained past data in association with each other.

2. The electronic apparatus of claim 1, wherein
the hardware processor is configured to obtain an event registered inside the electronic apparatus in association with the date added to the selected second image as the past data.

3. The electronic apparatus of claim 1, wherein
the hardware processor is configured to obtain news distributed in a period including the date added to the selected second image as the past data via an external network.

4. The electronic apparatus of claim 1, wherein
each of the first images includes a person, and
the hardware processor is configured to:
calculate a feature amount of a face area of the person included in each of the first images by analyzing each of the obtained first images;
classify the first images into a plurality of groups based on the calculated feature amount; and
select the first images classified into at least one of the groups as the second image.

5. The electronic apparatus of claim 4, wherein
the hardware processor is configured to:
specify a group having the largest number of classified first images out of the groups, and
select the first images classified into the specified group as the second image.

6. The electronic apparatus of claim 1, wherein
the hardware processor is configured to present, if a plurality of second images are selected, the second images in an order of dates added to the second images.

7. The electronic apparatus of claim 6, wherein
the hardware processor is configured to present, if the number of selected second images is greater than a first number, a predetermined second number of second images for each predetermined period out of the second images to which a date applicable to the period is added.

8. The electronic apparatus of claim 1, wherein
a location in which each of the first images is captured is added to the first image, and
the hardware processor is configured to obtain the past data based on a location added to the selected second image.

9. The electronic apparatus of claim 1, wherein
each of the first images includes an object, and
the hardware processor is configured to obtain the past data based on a result of a process for recognizing an object included in the selected second image.

10. The electronic apparatus of claim 1, wherein
each of the first images includes a character, and
the hardware processor is configured to obtain the past data based on a result of a process for recognizing a character included in the selected second image.

11. The electronic apparatus of claim 1, wherein the hardware processor comprises:
means for obtaining a plurality of first images to which a capture date is added;
means for selecting a second image from the first images based on a result of analysis of each of the obtained first images;
means for obtaining past data related to a period in which the second image is captured, based on a date added to the selected second image; and
means for presenting the selected second image and the obtained past data in association with each other.

12. A method comprising:
obtaining a plurality of first images to which a capture date is added;
selecting a second image from the first images based on a result of analysis of each of the obtained first images;
obtaining past data related to a period in which the second image is captured, based on a date added to the selected second image; and
presenting the selected second image and the obtained past data in association with each other.
